(19) United States
(12) Patent Application Publication
(10) Pub. No.: US 2002/0129149 A1
(43) Pub. Date: Sep. 12, 2002

(54) Method and system for automatically directing a web user to a selected web server

(76) Inventor: Kenneth Schulz, Los Altos, CA (US)

Correspondence Address: HEWLETT-PACKARD COMPANY, Intellectual Property Administration, P. O. Box 272400, Fort Collins, CO, 80527-2400, US

(21) Appl. No.: 09/799,989

(22) Filed: Mar. 6, 2001

(51) Int. Cl. G06F 15/173

(52) U.S. Cl. 709/226; 709/238; 709/229

(57) ABSTRACT

The present invention provides a computer implemented method for directing a web user to a particular web server within a web server system that has a plurality of web servers. In one embodiment, in operation, a user ID is incorporated in a message from each user to the server system. The user is connected to a server and the user ID is then used to re-direct, if necessary, the user to the proper server.

### BACKGROUND

Web servers are commonly made available to web users through the Internet. Web servers can provide a variety of on-line services such as on-line support and help services. For example, through its IT Resource Center™, Hewlett Packard provides various support services including virtual help desks, case management tools, and software upgrade/patch sources for its customer's IT support personnel throughout the world.

In providing the web service(s), a “virtual” web server may be implemented from several separate servers in order to handle the necessary load requirements. With users spread over a wide geographic area, for performance optimization, it is common to geographically distribute the servers over a corresponding area for servicing the users. However, in order to take advantage of this approach, users should be linked to their closest servers.

Conventional systems use distribution routers for estimating a “closest” server and causing a user to be routed to that server. For example, Cisco Systems DistributedDirector™ provides Internet traffic load distribution between multiple geographically-dispersed servers.

In doing so, it uses routing table information in the network infrastructure along with client-to-server topological proximity and/or client-to-server link latencies to make “network intelligent” load distribution decisions in attempting to transparently direct clients to a closest available server. Such distribution (or re-direction) devices work well—especially when identification information has not been attained for a web user connecting to the web service.

However, when such information has been acquired, it is desirable to more assuredly link users to a selected, pre-assigned server. In addition, a web provider may wish to have users directed to its pre-assigned server within the virtual web server system based on considerations other than geographic proximity.

Various approaches have been used to carry out these pre-assigned user to server schemes. For example, with one approach, user to server mapping information is stored in a database that is accessible to each server. When a given server receives a web session request (e.g., through a login request), the server first checks the database to determine if the user is at the “correct” server and if not, causes it to be routed to the pre-assigned server. Unfortunately, this scheme is inefficient with each server having to access the database each time a user makes a web session request. In many instances, the database will be remotely located with respect to an accessing web server. Even if a separate database is used for each server, the different database instances must be updated on a regular basis.

In another approach, browser cookies (data downloaded to the user's system from a server) are used to locally store the user's pre-assigned server information. When the user makes the initial web session request, its browser obtains the correct server address from the cookie and thereby causes the user to be connected with this appropriate, pre-assigned server. Unfortunately, solutions that incorporate the use of cookies are less desirable because many users, for various reasons, will disable cookie functions in their browsers. This causes redirection schemes that use cookies to be intolerant and unreliable.

### SUMMARY OF THE INVENTION

These and other objects, features and technical advantages are achieved with a computer implemented system and method for directing a web user to a pre-assigned web server within a virtual web server of the present invention. In one embodiment, this system and method operate such that a first web server within a plurality of web servers, a user ID is received from the web user. The user ID has a server identifier that identifies the pre-assigned server. The pre-assigned server is then identified from the server identifier. Finally, if necessary (i.e., the first server is not the same as the pre-assigned server), the user is redirected to the pre-assigned server so that the user engages in a web session with the pre-assigned web server.

### BRIEF DESCRIPTION OF THE DRAWINGS

FIG. 1 shows a block diagram of a virtual web server system of the present invention;

FIG. 2A shows a log-in screen with an exemplary user ID having a server identifier of the present invention;

FIG. 2B shows a screen that appears after the user ID is submitted through the log-in screen of FIG. 2A; and

FIG. 3 shows one embodiment of an ID parser routine of the present invention.

### DETAILED DESCRIPTION

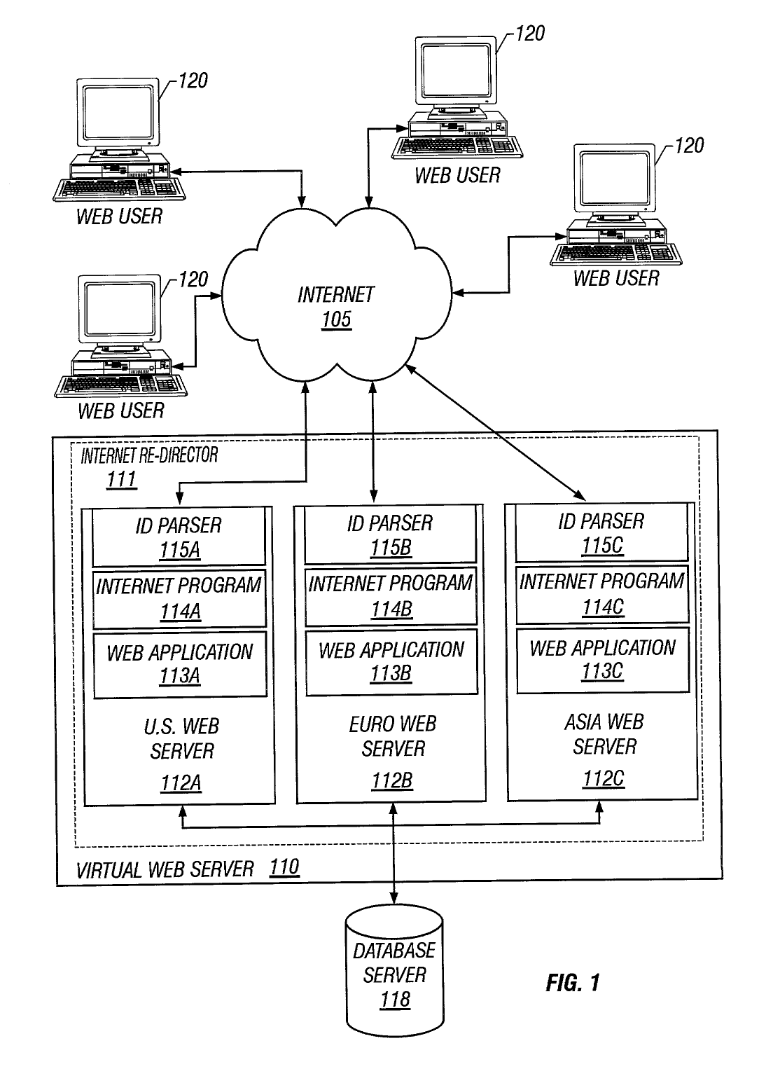

FIG. 1 shows one embodiment of web server 110 of the present invention. Web server 110 is connected to multiple web user computers 120 through, by way of example, the portion of the Internet 105 known as the World Wide Web (the Web). Web server 110 is also operably connected to database server 118 which advantageously can be located anywhere in the world and, if desired, can be multiple data bases. In the depicted embodiment, web server 110 includes three separate web servers: 112A, 112B, and 112C. In this embodiment, web server 112A is located in the United States; web server 112B is located in Europe; and web server 112C is located in Asia. Each web server, 112A through 112C, is operably connected to the other web servers 112, as well as to the database server 118, e.g., via a secure network link. Web server 110 also includes (or is operably linked to the Internet through) a distribution (or redirector) router 111, such as a Cisco Systems DistributedDirector™ router. Depending on the particular implementation, distribution router 111 may run on a separate machine or on one or more web servers 112. Together, the three web servers, 112A, 112B, and 112C, provide redundant web server functionality to different web users throughout the world. That is, in a sense, the physical web servers, 112A through 112C are functionally in parallel with one another except that a user is directed (or re-directed) to a pre-assigned one of them based on its unique user ID, which will be addressed in greater detail below.

Database server 118 is a conventional database server for storing and providing to web servers 112 web server information (e.g., registered user information, customer/equipment profiles) in support of the web application being provided on web servers 112. Database server 118 can be implemented with any suitable database scheme, including but not limited to, flat-file, hierarchical, relational, and object-oriented databases.

Web user computers 120 are any form of Internet access device, including a computer or Internet appliance with (and in some cases without) an appropriately operable web browser. Likewise, the web servers 112 and database server 118 can be implemented with any suitable combination of one or more computers, including but not limited to mainframes, workstations, or personal computers, running operating systems such as Windows NT, UNIX, LINUX, or any other computer operating system.

Each web server 112, of the group of servers shown as 110, includes a web application program(s) 113, an Internet (or Internet enabling) program 114 and an ID parser 115. Web application programs 113 execute and provide to web users (via web user computers 120) a web service (or services) offered by the virtual web server 110 for assisting or providing information to a user in relation to an organization's business or activities. Web applications could include, but are not limited to, any service or services provided through a web server. For example, a web server could provide customer support tools such as virtual help desks, case management tools, and software upgrade/patch sources. In one particular embodiment, web servers 112 facilitate an IT Resource center for providing IT support personnel with various IT support tools.

Web tool information and forms generated by web application programs 113 are typically formatted in a hypertext mark-up language (HTML) and can include text, programs, graphics, video, and audio portions. Any suitable programming scheme may be used for implementing web application program 113. In one embodiment, a Java servlet on a Windows NT platform is used for dynamically generating the web pages with web page templates. As used herein, a servlet comprises a Java application that runs in a Web server or application server and provides server-side processing. Persons of skill will recognize, however, that other schemes such as CGI scripts, Active Server Pages (ASPs) and plug-ins written, e.g., in C, C++ and Perl for specific Web services can be used in cooperation and/or in replacement of servlet methods.

Internet programs 114 enable web servers 112 to function as web servers thereby providing web users 120 with access to the web server service(s). They may be implemented with any suitable Internet enabling software such as Apache, Microsoft IIS, or Netscape Enterprise Server.

ID parser 115 parses a server identifier from an incoming user ID (e.g., in an HTML log-in request) and causes the web user to be connected to the pre-assigned web server 112 (112A, 112B, or 112C in the depicted embodiment) that is identified by the server identifier. ID Parser 115 can be implemented in any suitable scheme. For example, it could be implemented with a Perl or C routine running in cooperation with Internet program 114 to serve as an interface between a web server 112 and a web user 120 for receiving and processing a user ID before a web session for the virtual web server is undertaken by a particular web server 112. A method for implementing an ID Parser 115 will be addressed in greater detail below.

In operation, a web user 120 initiates a web session with web server 110 by submitting a request with the appropriate URL through its browser to virtual web server 110. The request is then received and processed within internet re-director 111. The re-director directs the request to one of web servers 112A, 112B, or 112C, based on an estimation as to where it “thinks' the session should occur. In response to receiving this request, the selected web server returns back to the user a log-in form for acquiring the user's ID. The user then “logs into” virtual web server 110 by returning back to the selected server its user ID. An ID parser (115A, 115B, or 115C) that is within this selected web server, processes the received user ID and directs (if necessary) the user to its pre-assigned web server 112A, 112B, or 112C, whose identity is derived from the user ID. From here, the user engages in a web session with this pre-assigned web server.

In one embodiment, a user, in engaging in a web session with a virtual web server begins by logging into the virtual web server. In doing so, the user provides the virtual web server with a user ID and possibly an associated password.

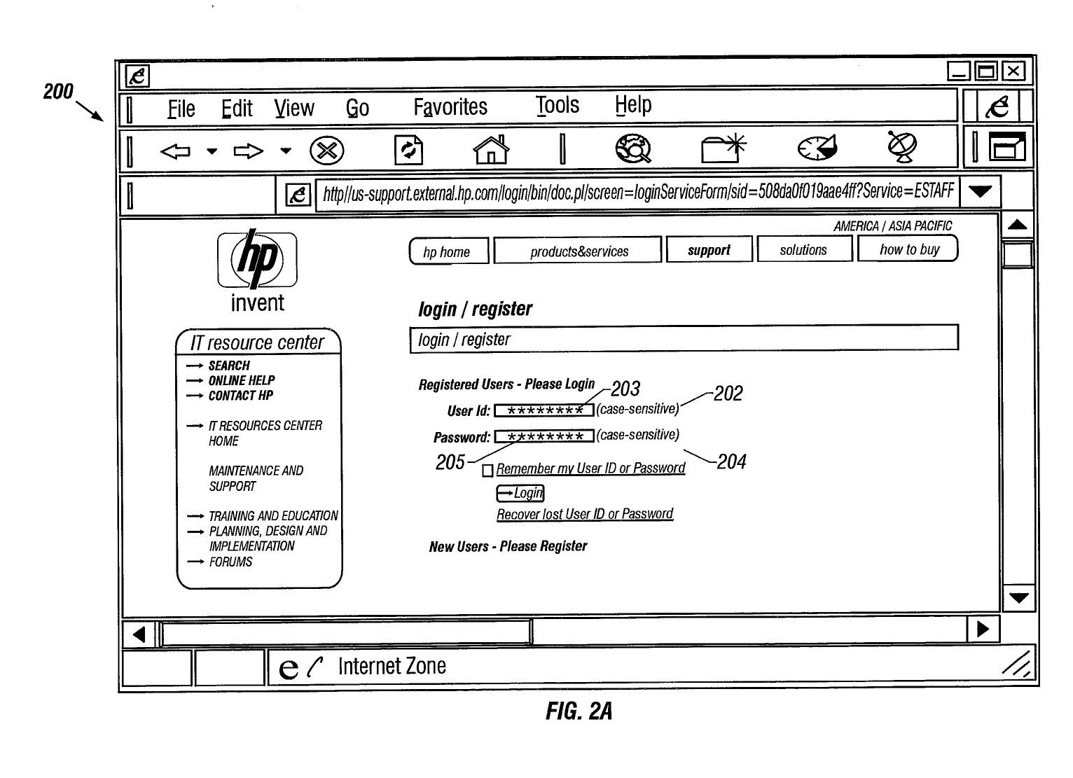

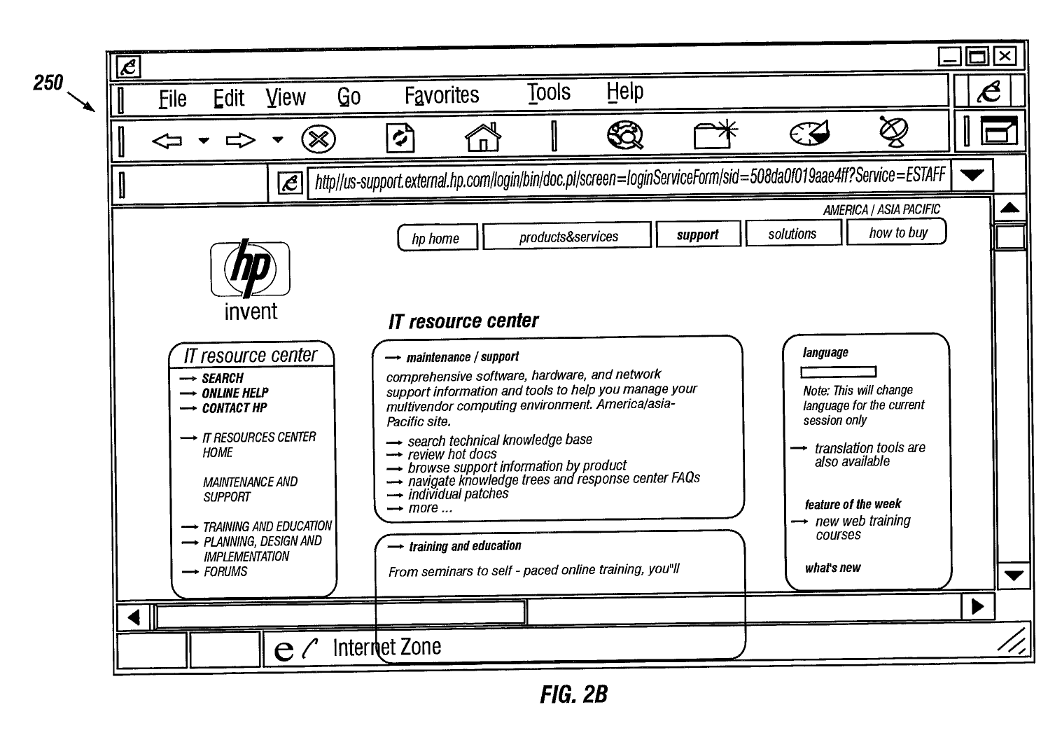

FIG. 2A shows an exemplary log-in screen 200 for an “IT Resource Center” application that is provided through a virtual web server. Log-in screen 200 has user ID field 202 for receiving user ID 203 and password field 204 for receiving an associated password 205.

FIG. 2B shows screen 250, which appears after the user has entered the user ID and password. From here, the user engages in the web session with the virtual web server via a link with its pre-assigned web server.

A user ID generally comprises a string of alphanumeric characters unique to each user with a server identifier incorporated therein. Various types of server identifiers including character string and characteristics type server identifiers may be used. A character string identifier contains one or more characters occurring—either continuously or discontinuously—in a known location(s) (e.g., beginning portion, end portion) of the user ID. A prefix identifier is an example of such a character string identifier. A prefix identifier contains a predefined number of one or more characters at the beginning of the user ID character string. When receiving the user ID, the ID Parser checks these beginning identifier characters to identify the pre-assigned web server to which the user is directed for its virtual web server session. With the exemplary user ID, “CA599287”, of FIG. 2A, a two character prefix identifier is used. The prefix identifier in this example is “CA” (California), which associates the user ID with the U.S. web server, 112A. The other six characters, “599287” uniquely identify the particular user.

In contrast, a characteristics type server identifier is implemented based on predefined characteristics (e.g, type, size) of the user ID. The ID parser examines the entire (or at least a relevant aspect) of the user ID to identify the pre-assigned server from the predefined characteristics. For example, the size (character string length) of the user ID could convey the pre-assigned server. For example, with the system of FIG. 1, three separate user ID length ranges (e.g., 4-5, 6-7, 8-9) length strings could be used. The user would be instructed to select an ID with a length corresponding to that of a range for its pre-assigned server. If it were to be assigned to the US server, the user would be instructed to select a user ID having 4 or 5 characters. In this way, the user can choose its own user ID without it having to be modified by the web provider so long as the user selects a user ID comporting with characteristics specified by the web provider corresponding to the pre-assigned server.

Before a server identifier can be incorporated into the user ID, the pre-assigned server must be determined (e.g., by the virtual web server provider). A server may be determined (or pre-assigned) for a particular user in various suitable ways. For example, it may be selected by the user or derived based on the user's response to a question(s) (e.g., residence, computer location). It could also be determined by the web server provider based on information not directly acquired from the user, such as customer status, load balancing considerations, or any other suitable parameters.

Once a desired pre-assigned server is determined, an appropriate server identifier can then be incorporated into a user ID. A server identifier may be incorporated into a user's ID in any suitable manner. With a character string identifier, the user may be assigned a user ID with the appropriate character string server identifier. In this way, the user ID is assured to include the proper server identifier in the proper location of the user ID. If it is desired for the user to be able to at least partially select its own user ID, a different approach may be used. For example, after checking to confirm that this selected user ID is available, the Virtual server could then attach to it the appropriate server identifier in the appropriate portion of the user ID and present the modified ID back to the user for its use thereafter. On the other hand, a characteristics type identifier would allow the user to select its own user ID that didn't have to be modified.

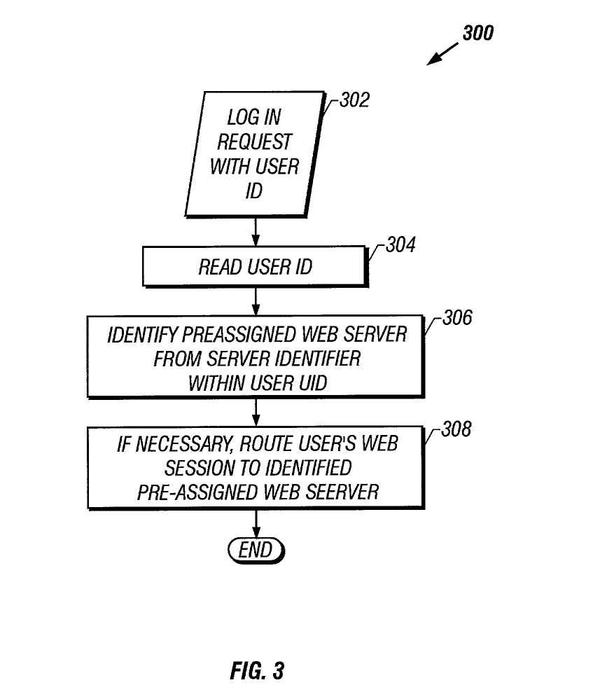

FIG. 3 shows one embodiment of a portion 300 of a routine for parsing a user ID for directing (or routing) a web user to a pre-assigned web server within a virtual web server. Initially, a log-in request with user ID 302 is received at web server 112 (A, B, or C). The ID parser within this server then reads the received user ID. At 306, the pre-assigned server is identified from the server identifier within the user ID. Finally, at 308, the user is re-directed (if necessary) to the appropriate, pre-assigned server.

The particular way in which the ID parser identifies the pre-assigned server from the user ID will depend upon the type of server identifier embedded therein. For example, if a 2 character, prefix identifier is used, the parser would examine the first two characters of the user ID and map them (e.g., within a look-up table) to the pre-assigned server. On the other hand, if a characteristics type identifier is used, the parser would examine the relevant characteristics of the received user ID.

The ID parser could use any suitable method to cause the user to be routed (or redirected) to the pre-assigned server. For example, in one embodiment, a web page with a hyper-text link to the pre-assigned server is sent back to the user. In the web page, the user is instructed to select the link, and upon doing so, is connected to the pre-assigned server. In another embodiment, a web page document with a meta re-direct tag included therein is returned to the user. The re-direct tag, when executed by the user's browser, automatically and transparently causes the user to be connected to the pre-assigned server.

For example, while the depicted virtual web server uses a server side ID parser, a client side implementation could also be used. After receiving the initial request from the user, the virtual web server could return back to the user, along with the log-in page, an ID parser script to be executed by the user's browser. After the user entered its user ID into an appropriate field, the executing parser script would identify the pre-assigned server therefrom and re-direct (if necessary) the user to that server.

What is claimed is:

1. A system for providing a web service to a plurality of web users, said system comprising:
at least two web servers, each web server including a user ID parser for re-directing each web user to a pre-assigned one of said web servers based on identification information incorporated within a user ID of each said web user and, wherein said identification information includes the identity of said pre-assigned server.

2. The system of claim 1 wherein said identification information is a character string identifier.

3. The system of claim 2 wherein said character string identifier is a prefix identifier.

4. The system of claim 1 wherein said identification information is a characteristics type identifier.

5. The system of claim 4 wherein said characteristics type identifier corresponds to the number of characters in said user ID.

6. The system of claim 1 further including an internet re-director initially selecting a particular web server within said at least two web servers to receive said user ID.

7. A computer implemented method for directing a web user to a pre-assigned web server within a plurality of web servers, said method comprising the steps of:
receiving from the web user a user ID at a first web server within said plurality of web servers, the user ID having a server identifier that identifies a particular server;
identifying at said first web server from said server identifier said particular server; and
re-directing the user to said particular server if the first web server is not said particular web server.

8. The method of claim 7 wherein the server identifier is a character string identifier.

9. The method of claim 8 wherein said identifying step includes the step of mapping characters from the user ID corresponding to the character string identifier to the pre-assigned server in order to identify it.

10. The method of claim 9 wherein the character string identifier is a prefix identifier.

11. The method of claim 7 wherein the server identifier is a characteristics type identifier.

12. The method of claim 11 wherein the characteristics type identifier is based on the character length of said user ID.

13. The method of claim 7 wherein the user comprises a user computer with an executing browser, and said re-directing step includes the step of sending to the user a web page document with a re-direct tag to be executed by said browser for modifying said user ID.

14. A memory storage device having instructions for implementing an ID parser routine method for a web server system having two or more web servers within said system, said routine method comprising the step of:
acquiring a user ID from a user's log-in request to a web server, the user ID having an embedded server identifier for identifying a particular web server within said system;
identifying said particular web server from the identified server identifier; and
causing the user to engage in a web server session with said particular web server.

15. The memory storage device of claim 14 wherein the instructions for implementing the ID parser routine are to be executed on at least one of the two or more web servers that receives the log-in request from the user.

16. The memory storage device of claim 15 wherein the instructions for implementing the ID parser routine are to be executed by a user computer browser.

17. The memory storage device of claim 14 wherein the server identifier is a character string identifier.

18. The memory storage device of claim 14 wherein the server identifier is a characteristics type identifier.

19. The memory storage device of claim 14 wherein the two or more servers are physically located in different geographical locations, and the particular web server corresponds to the one of the two or more web servers that is most proximate to the user.

20. The memory storage device of claim 14 wherein the step of causing the user to engage in a web server session with the particular web server includes transmitting to the user a re-direct tag to be executed by a user web browser that transmitted the log-in request to the web server system.

21. A system for connecting any one of a plurality of users to a proper one if a plurality of servers, said system comprising:
means for connecting any said user to any said server;
means enabled upon a connection of a particular user to a server for determining a server ID from information obtained from said particular user; and
means operable when a determined server ID does not match the server to which said particular user is connected, for re-directing said particular user to the server corresponding to said determined ID.

22. The system of claim 21 wherein said ID determining means is co-resident with said server to which said particular user is connected.

23. The system of claim 21 wherein said re-directing means includes a data base operationally common to at least said originally connected server and to said re-directed server.

24. The system of claim 21 wherein said servers are geographically dispersed.
